(19) United States
(12) Patent Application Publication
(10) Pub. No.: US 2016/0347257 A1
(43) Pub. Date: Dec. 1, 2016

(54) PORTABLE ELECTRONIC DEVICE AUTOMOBILE MOUNT

(71) Applicant: Chad M. Buchanan, Mequon, WI (US)

(72) Inventor: Chad M. Buchanan, Mequon, WI (US)

(21) Appl. No.: 14/726,412

(22) Filed: May 29, 2015

(51) Int. Cl. B60R 11/02; F16M 13/02

(52) U.S. Cl. CPC B60R 11/02; B60R 11/0241; F16M 13/02; B60R 2011/0008

(57) ABSTRACT

A mount for use with a pair of automobile louver blades includes a base, a coupler extending from the base to be coupled to a portable electronic device and a pair of resiliently flexible prongs extending from the base and spaced to grip a pair of spaced automobile vent louver blades.

### CROSS REFERENCE TO RELATED APPLICATIONS

The present application is related to co-pending U.S. patent application Ser. No. 14524587 filed on Oct. 27, 2014 by Chad M. Buchanan and entitled MOUNT LOCKING SYSTEM, the full disclosure of which is hereby incorporated by reference.

### BACKGROUND

The portability of electronic devices has led to the creation of various mounts for securing the electronic devices. For example, electronic devices such as tablet computers, smart phones, personal data assistants, still and video cameras are now being mounted to bikes, paddle boards, helmets, and the like. Unfortunately, existing mounts are sometimes unreliable or are difficult to connect the electronic device to the mount.

### BRIEF DESCRIPTION OF THE DRAWINGS

FIG. 1 is a perspective view of an example portable electronic device vehicle vent mounting kit including a plug and a mount.

FIG. 2 is a rear perspective view of a case for use with the kit of FIG. 1.

FIG. 3 is a rear perspective view of a portable electronic device automobile mounting system illustrating the plug of FIG. 1 coupled to the case of FIG. 2, carrying a portable electronic device, and the mount of FIG. 1 aligned with the plug.

FIG. 4 is a front perspective view of the mount of FIG. 1 coupled to the case and portable electronic device of FIG. 3 by the plug of FIG. 1.

FIG. 5 is a fragmentary view illustrating connection of the mount of FIG. 1 to the louver blades of a vent of an automobile or vehicle.

FIG. 6 is a fragmentary perspective view of the mount of FIG. 1 secured to the louver blades of the vent of FIG. 5.

FIG. 7 is a fragmentary perspective view illustrating the case and portable electronic device of FIG. 4 mounted to the mount of FIG. 1 while the mount is secured to the louver blades of the automobile vent.

### DETAILED DESCRIPTION OF EXAMPLES

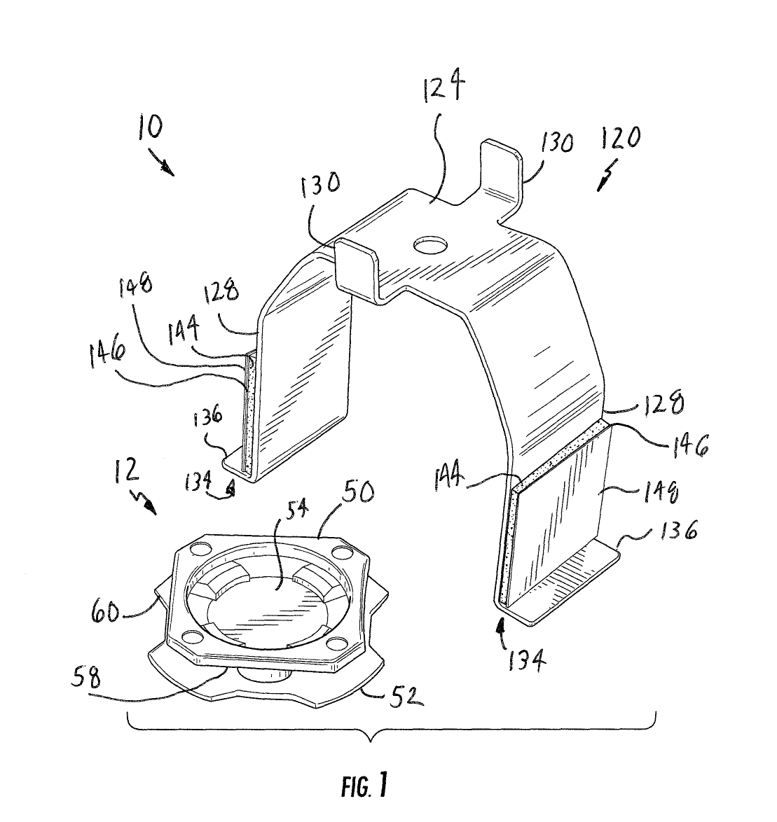

FIG. 1 is a perspective view of an example portable electronic device vehicle vent mounting kit 10 for mounting and supporting or retaining a portable electronic device, such as a smart phone, flash memory drive, personal data assistant, tablet computer or other electronic device, adjacent to and/or along a vent of an automobile or vehicle. As will be described hereafter, mounting kit 10 is for use with a case that holds a portable electronic device, wherein mounting kit 10 and the case form a portable electronic device mounting system. Mounting kit 10 comprises plug 12 and portable electronic device automobile mount 120.

Plug 12 comprises an adapter to be removably coupled to a case to facilitate removal coupling of mount 120 to the case. In the example illustrated, plug 12 adapts an existing case for use with the particular coupling mechanism provided on mount 120. In the example illustrated, plug 12 is configured to be releasably or removably connected to a case while providing a magnet to assist in magnetically retaining the case to mount 120. For purposes of this disclosure, the phrase “configured to” denotes an actual state of configuration that fundamentally ties the stated function/use to the physical characteristics of the feature proceeding the phrase “configured to”.

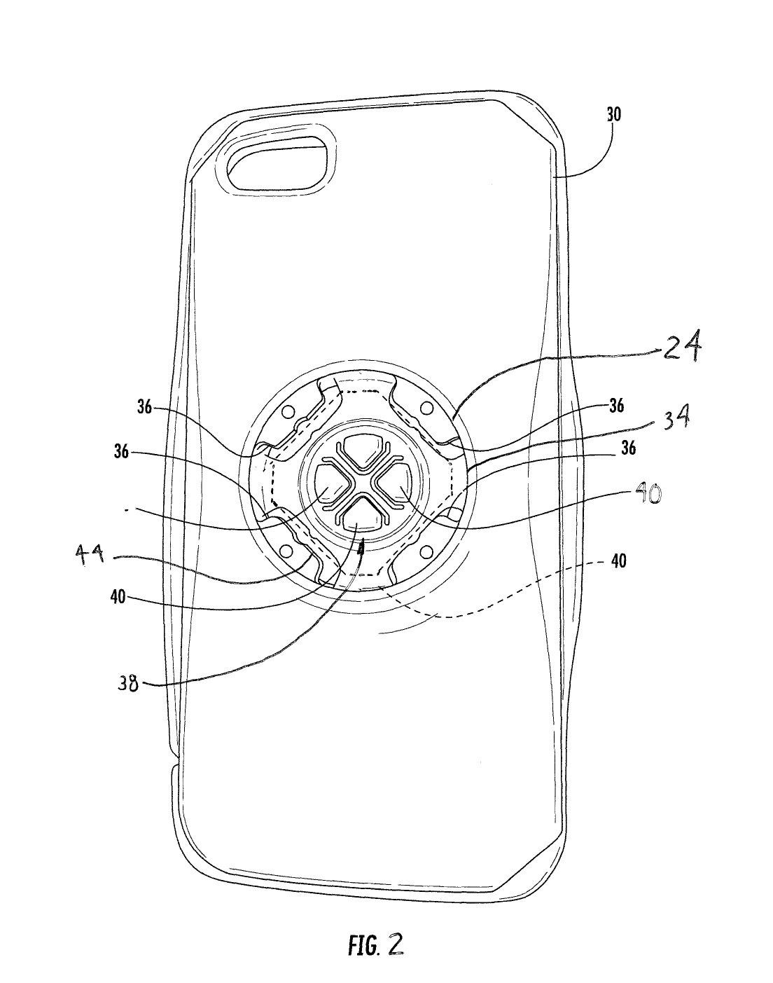

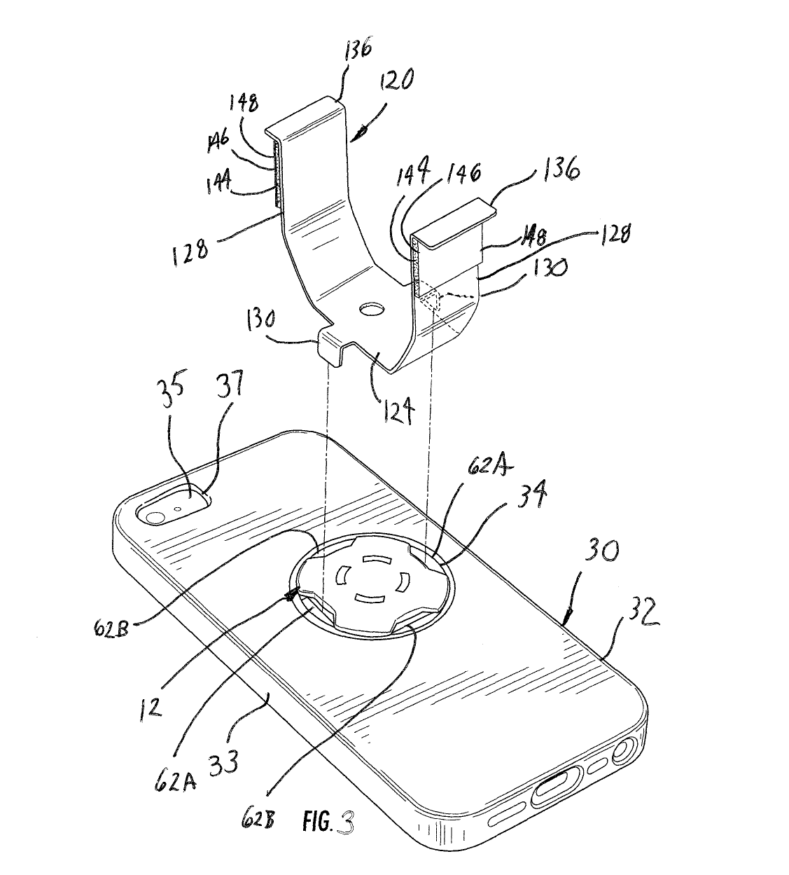

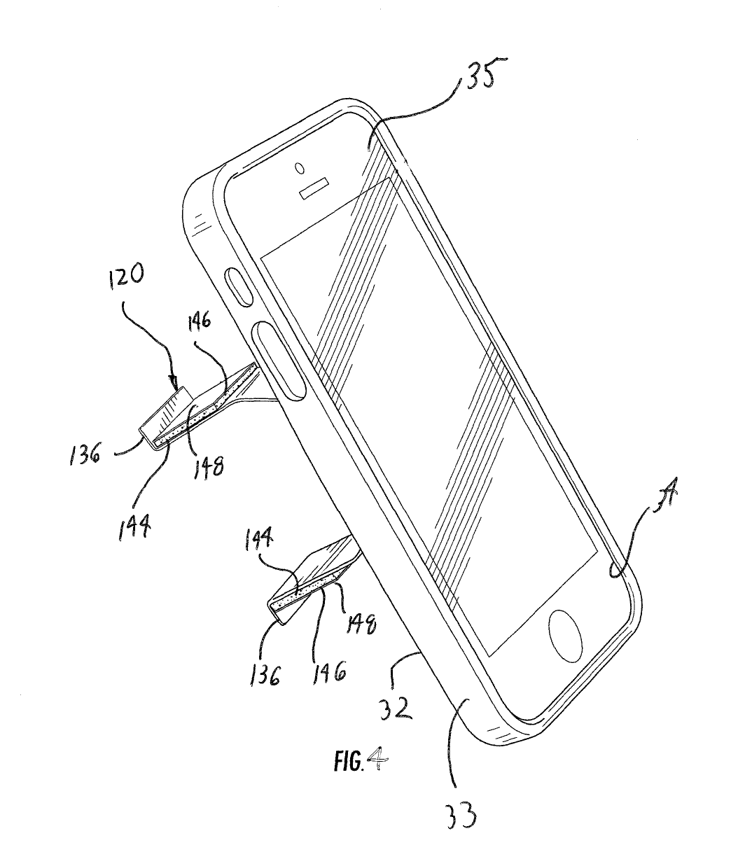

In the example illustrated, plug 112 is usable with case 30 illustrated in FIG. 2. Case 30 comprises a housing which removably or releasably receives a portable electronic device such that a display of the portable electronic devices visible through case 30. As shown by FIGS. 2-4, case 30 comprises a back panel 32 and sidewalls 33 forming a cavity 34 is receives a portable electronic device, such as portable electronic device 35 (shown in FIGS. 3 and 4). Back panel 32 and sidewalls 33 comprise various openings located in sized to facilitate use of portable electronic device 35. For example, back panel 32 comprises camera opening 37 while sidewalls 33 comprise various openings 39 facilitating access to volume controls, the universal serial bus port, a microphone plug-in port and the like. In some implementations, portions of case 30 may include flexible portions allowing portions of case 30 to be manually depressed to apply force to one or more controls of portable electronic device 35. Such openings may vary depending upon the particular configuration of portable electronic device 35.

As shown by FIG. 2, rear panel 32 of case 30 comprises a female lock receiver. Female lock receiver is described in detail in co-pending U.S. patent application Ser. No. 14524587 filed on Oct. 27, 2014 by Chad M. Buchanan and entitled MOUNT LOCKING SYSTEM, the full disclosure of which is hereby incorporated by reference. Female lock receiver 24 Female lock receiver 24 comprise the structure which removably receives a portion of mail lock 26. Female lock receiver 24 cooperates with mail lock 26 to secure electronic device in a desired orientation relative to a structure which supports lock 26. In the example illustrated in FIG. 2, female lock receiver 24 is formed in electronic case 30 which removably receives an electronic device, such as a smart phone, flash memory player, personal data assistant or tablet computer. In the example illustrated, female lock receiver 24 is integrally formed as part of a single unitary body with electronic case 30. In other implementations, female lock receiver 24 is removably or fixedly mounted, welded, bonded or fastened to electronic case 30. In yet another implementation, female lock receiver 24 is integrally formed as part of a single unitary body with the housing of the electronic device 30 itself or is fixedly mounted, welded, bonded or fastened directly to a housing of the electronic device itself

As shown by FIG. 2, female lock receiver 24 comprises cavity 34, overhangs 36, cavity floor 38 and catches 40. Cavity 34 comprise an opening extending through panel 32. As noted above, in one implementation, panel 32 is integrally formed as part of a single unitary body as part of case 30. In other implementations, panel 32 is part of a structure that is removably or fixedly fastened, welded, bonded to case 30. In yet other implementations, panel 32 is part of a structure that is removably or fixedly mounted directly to a housing of the electronic device itself or is integrally formed as part of the electronic device housing. Because female lock receiver 24 comprises a female member comprising cavity 34, case 30 (or the housing of electronic device itself) omits structure that project from case 30 (or the housing electronic device itself). As a result, case 30 (or the housing of the electronic device itself) is less likely to inadvertently catch up on external objects and maybe more easily carried within a person's pocket.

Overhangs 36 comprise structures that project from panel 32 into and partially across cavity 34. Overhangs 36 define an insertion opening 44 through which plug 12 is freely inserted and withdrawn when aligned with insertion opening 44. In the example illustrated, overhangs 36 form a polygonal insertion opening 44 for receiving a corresponding polygonal shaped portion of lock 26. In the example illustrated, overhangs 36 form a square or substantially square (cut off corners) insertion opening 44 for receiving a correspondingly shaped square shaped portion of plug 12.

Cavity floor 38 comprise a structure supported within cavity 34 and below insertion opening 44 and overhangs 36. In one implementation, cavity floor 38 comprises a spring-like structure, configured to resiliently flex in a direction perpendicular to insertion opening 44. In the example illustrated, cavity floor 38 comprises four resiliently depressable catches 40.

Catches 40 comprise two or more structures resiliently projecting from cavity floor 38 so as to resiliently flex or deflect relative to cavity floor 38 and relative to insertion opening 36. Catches 40 are configured to resiliently deflect as plug 12 is partially inserted into cavity 34. Catches 40 resiliently urge portions of plug 12 into frictional engagement with overhangs 36 to inhibit inadvertent or accidental rotation of plug 12 from a secured position in which plug 12 is out of alignment with opening 44 two a withdrawal position in which the shape of plug 12 received within cavity 34 is aligned with opening 44. In another implementation, cavity floor 38 comprises a fixed rigid or stationary structure or surface.

As you may FIG. 1, plug 12 comprises lock 50, top 52 and magnet 54. Lock 50 comprises a structure to be received within opening 44 and to be rotated within cavity 36 until out of alignment with opening 44 with portions of lock 50 captured beneath overhangs 36. In the example illustrated, lock 50 at a substantially square shape for being inserted into cavity 36 through the substantially square shaped insertion opening 44. FIG. 2 illustrates an outline of lock 50 (in broken lines) inserted through insertion opening 44 into cavity 34. Once inserted and depressing catches 40, lock 50 is rotatable to position the corners of lock 50 below corresponding catches 36 such that lock 50 is retained in place within cavity 34. Although illustrated as being substantially square, in other implementations, insertion opening 44 and/or lock 50 may have other shapes.

Top 52 extends from lock 50 and is spaced from lock 50 so as to form a channel 58. Top 52 comprises cutouts or notches about its perimeter. As shown by FIG. 3, in the example illustrated, when plug 12 is inserted into cavity 34 of case 30, the notches 60 are spaced from the perimeter of cavity 34 to form slits or apertures 62A and 62B. Apertures 62A are angularly offset from apertures 62A by 90°. Apertures 62A receive portions of mount 120 when case 30 (and electronic device 35) is being supported in a portrait or vertical orientation. Apertures 62B receive portions of mount 120 when case 30 (and electronic device 35) is being supported in a landscape or horizontal orientation. In other implementations, plug 60 may continuously bound or surround apertures 62. In some implementations, plug 60 may omit one of the sets of apertures 62A, 62B. In other implementations, plug 60 may have other configurations to facilitate releasable connection to case 30 and other configurations to facilitate releasable connection to mount 120.

Magnet 54 comprises a ferromagnetic material bonded, captured or otherwise secured to plug 12 so as to apply a magnetic force to attract mount 120. In the example illustrated, plug 12 is integrally formed in the single unitary body out of the robber or polymeric material. In one implementation, plug 12 is molded about magnet 54 to retain magnet 54 in place to partially surround magnet 54. In one implementation, magnet 54 comprises a rare earth magnet. In some implementations, magnet 54 may be omitted. In yet other implementations, plug 12 is alternatively permanently provided as part of or integrally formed as part of case 30 or as part of the housing of portable electronic device 35. For example, in one implementation, the back of case 30 may provide apertures 62 and may incorporate therein a magnet, such as magnet 54. In yet other implementations, other couplers are usable for releasably connecting case 30 or other cases to mount 120.

As shown by FIGS. 1 and 2, mount 120 comprises a clip having a base 124, prongs 128 and projections or prongs 130. Base 124 comprises a structure from which prongs 128, 130 extend. Although illustrated as being a rectangular flat plate, in other implementations, base 124 may have other shapes and configurations. In the example illustrated, base 124 is formed from a ferrous material facilitating magnetic attraction to magnet 54 of plug 12. In other implementations, base 124 have secured thereto a ferrous plate or other structure of material for attraction to magnet 54. In still other implementations, base 124 itself may be magnetic or may carry a permanent magnet. In implementations where magnet 54 is omitted, base 124 need not be magnetic or ferrous.

Prongs 128 extend from opposite sides of base 124 in a first plane. Prongs 128 are configured to be received between a pair of spaced automobile or vehicle vent louver blades. In the example illustrated, each of prongs 128 is resiliently flexible, allowing such prongs 128 to be inwardly flexed towards one another during insertion between the pair of spaced louver blades, wherein upon being released, prongs 128 to resiliently widen so as to grip mutually facing surfaces of the louver blades in the example illustrated, each of prongs 128 comprises an end portion 134 and forming a hook 136 which facilitate retention of prongs 128 with respect to the pair of vent louver blades.

As further shown by FIG. 1, in one implementation, the outer faces of prongs 128 which are to contact corresponding option faces of a louver blade have secured thereto a soft, resilient compressible pad 144 to facilitate gripping and reduce marring of the louver blades. In one implementation, the compressible pad is bonded to prongs 128. In one implementation, the pad 144 comprises a rubber panel. In yet other implementations, the In one implementation, the pad 144 comprises a foam pad.

In the example illustrated, the outer face or surface of each of pads 144 carries an adhesive layer 146 which is initially covered by a peel off covering or panel 148. Removal of panel 148 exposes the adhesive layer 146 when mount 120s to be secured to an automobile vent, allowing prongs 128 to be releasably secured to the blades of the automobile vent. In other implementations, adhesive layer 144 may be omitted. In other implementations, compressible pads 144 may be omitted. In some implementations, pads 144 may be omitted, wherein adhesive is applied are carried by the surface of prongs 128 (at locations beneath the presently illustrated pads 144). In yet other implementations, end portions 134 are additionally or alternatively encapsulated by soft polymer or rubber-like material coating to facilitate gripping and reduce marring of the louver blades. In other implementations, such a coating may be omitted.

Prongs 130 comprise projections extending from an opposite side of base 124 as prongs 128. Prongs 130 are configured to be removably fastened to are connected to the case of a portable electronic device. Prongs 130 serve as a coupler for coupling mount 120 to case 30 and/or the portable electronic device 35. In the example illustrated, prongs 130 are configured to be removably connected to case 30, such as wherein prongs 130 are received within one of the sets of apertures 62A, 62B. In the example illustrated, prongs 130 extend in a plane perpendicular to the plane in which prongs 128 extend from base 1124. In other words, prongs 130 extend perpendicular to prongs 128. As a result, prongs 130 support the mounted case side-to-side, rather than up-and-down against gravity. Moreover, this orientation facilitates forming prongs 130 and prongs 128 from a single stamped sheet of material. In other implementations, prongs 130 may extend in the same plane for the same directions as prongs 128 from base 124. In other implementations, prongs 130 have other configurations for being releasably connected to or snapped to a case of a portable electronic device, wherein the configuration of prongs 130 may depend upon the configuration of the mounting portion of the case.

In the example illustrated, mount 120 is integrally formed as a single unitary body but for pads 144, adhesive layer 146 and peel away layer 148. In one implementation, the entirety of mount 120 is formed from a single stamped sheet of metal, such as high carbon spring steel, bent and deformed to form base 124, prongs 128 and prongs 130. As a result, fabrication of mount 120 is inexpensive. In other implementations, mount 120 may have other configurations.

FIGS. 3-7 illustrate installation and use of mount the system comprising kit 10 and case 30. FIG. 3 illustrates how prongs 130 are inserted into apertures 62A. In another mode of use, prongs 130 or alternatively inserted into apertures 62B (depending on a desired orientation of case 30). Prongs 130 assist in maintaining the angular orientation of mount 120 relative to case 30 and inhibit mount 120 from sliding off of case 30. At the same time, magnet 54 (shown in FIG. 1) magnetically attracts the ferrous material of base 124 to inhibit separation of mount 120 from plug 12 and case 30. FIG. 4 illustrates mount 120 secured and retained to case 30 while case 30 is containing portable electronic device 35.

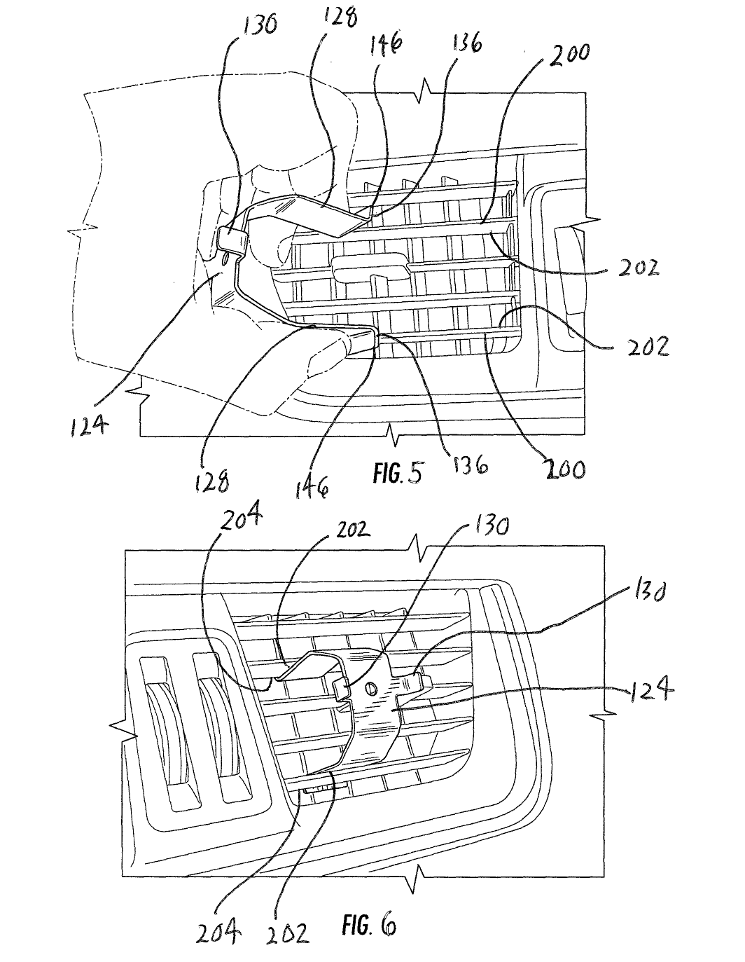

FIGS. 5-7 illustrate one effort of the use of the system provided by kit 10 in case 30. As shown by FIG. 5, a user grips prongs 128 and resiliently deforms such prongs or bends such prongs 128 towards one another such that prongs 128 are spaced from one another or such that the tips 146 of hooks 136 have a spacing from one another less than the spacing between the two vent louver blades 200 which are to be engaged by prongs 128. Such prongs are retained in a deformed state until hooks 136 are fully inserted behind their respective louver blades 200.

As shown by FIG. 45, once fully inserted behind their respective louver blades 200, prongs 128 are released. As a result, prongs 128 resiliently widen to contact or bear against the mutually of facing surfaces 202 of blades 200. In the example illustrated, hooks 136 abut or contact rear edges 204 of blades 200 to resist inadvertent withdrawal of mount 120 from such louver blades. In the example illustrated, prongs 128 are sufficiently spaced apart so as to contact and engage blades 200 that are spaced apart by one or more intermediate louver blades, providing a wider base of connection for enhanced ability. In other implementations, prongs 128 may have other spacings.

In the example illustrated, the spring steel forming prongs 128 and base 124 provide the resilient deflection of prongs 128. As a result, prongs 128 may be pinched towards one another against the spring force and subsequently released so to apply force against the louver blades 200 sandwiching the two prongs 128. In other implementations, prongs 128 are pivotally connected to one another by a hinge and are resiliently biased away from one another, in a widening direction, by a torsion spring. Such an implementation, manual pinching of prongs 128 is against the force of the torsion spring to facilitate insertion of prongs 128 between corresponding louver blades 200.

In other implementations, prongs 128 are alternatively configured to resiliently close so as to bear against face the louver blades that face away from one another. In one such implementation, prongs 128 are resiliently biased towards one another by a torsion spring, wherein mount 120 comprises handles or depression surfaces on an opposite side of the axis of the torsion spring as prongs 128, wherein the handles or depression surfaces are manually squeezable towards one another by which a person may manually widen prongs 128, against the force of the torsion spring, to facilitate positioning of the prongs about louver blades that are positioned between prongs 128 such that upon release, the prongs 128 resiliently returned towards one another to grip the sandwiched blades.

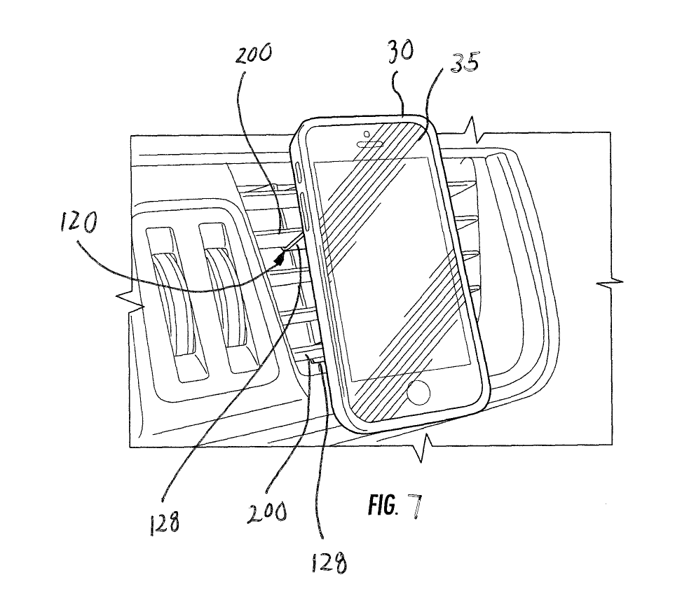

As shown by FIG. 7, case 30 is then mounted to prongs 130 as described above with respect to FIG. 3, wherein prongs 130 are received within apertures 62 and wherein magnet 54 magnetically holder retains case 30 against mount 120. As a result, portable electronic device 35 securely held in place in front of a vent of the interior of a vehicle or automobile. Portable electronic device 35 (along with its case 30 are easily withdrawn from attachment to the vent by user simply manually grasping case 30 and pulling case 30 away from the vent, wherein prongs 130 simply slide out of apertures 62 as the magnetic attraction between magnet 54 and base 124 is broken.

While the preferred embodiments of the disclosure have been illustrated and described, it will be appreciated that various changes can be made therein without departing from the spirit and scope of the disclosure. For example, although different example embodiments may have been described as including one or more features providing one or more benefits, it is contemplated that the described features may be interchanged with one another or alternatively be combined with one another in the described example embodiments or in other alternative embodiments. One of skill in the art will understand that the invention may also be practiced without many of the details described above. Accordingly, it will be intended to include all such alternatives, modifications and variations set forth within the spirit and scope of the appended claims. Further, some well-known structures or functions may not be shown or described in detail because such structures or functions would be known to one skilled in the art. Unless a term is specifically and overtly defined in this specification, the terminology used in the present specification is intended to be interpreted in its broadest reasonable manner, even though may be used conjunction with the description of certain specific embodiments of the present disclosure.

What is claimed is:

1. A portable electronic device automobile mount for use with a pair of automobile louver blades, the mount comprising:
a base;
a coupler extending from the base to be coupled to a portable electronic device; and
a pair of resiliently flexible prongs extending from the base and spaced to grip a pair of spaced automobile vent louver blades.

2. The mount of claim 1, wherein the pair of prongs comprise hooks extending in directions opposite to one another to engage interior edges of the spaced automobile vent louver blades.

3. The mount of claim 1, wherein the coupler comprises a second pair of prongs.

4. The mount of claim 3, wherein the second pair of prongs are angularly offset 90 degrees with respect to the pair of prongs.

5. The mount of claim 3, wherein the base, the pair of prongs and the second pair of prongs are integrally formed as a single unitary body from a metal and wherein the pair of prongs comprise hooks coated with a rubber or polymeric coating.

6. The mount of claim 4, wherein the coupler comprises at least one projection to be received within at least one corresponding detent associated with the portable electronic device.

7. The mount of claim 1, the coupler comprises is formed from a material so as to be magnetically attracted to a structure associated with the portable electronic device.

8. The mount of claim 1, wherein the base is formed from a ferrous material.

9. The mount of claim 1, wherein the pair of prongs have opposing faces to contact corresponding faces of the spaced automobile louver blades and wherein the mount further comprises a resiliently compressible pad on each of the opposing faces.

10. The mount of claim 9 further comprising an adhesive on each resiliently compressible pad to adhere the resiliently compressible pad to the corresponding face of the corresponding spaced automobile louver blade.

11. The mount of claim 10 further comprising a peel away cover panel on the adhesive.

12. The mount of claim 1, wherein the pair of prongs are spaced by sufficient distance such that the pair of spaced automobile vent louver blades gripped by the pair of prongs are separated by at least one intermediate automobile vent louver blade.

13. A automobile mount system comprising:
a case to removably receive and retain a portable electronic device; and
a mount for use with a pair of automobile louver blades, the mount comprising:
a base;
a coupler extending from the base to be coupled to a portable electronic device; and
a pair of resiliently flexible prongs extending from the base and spaced to grip a pair of spaced automobile vent louver blades.

14. The system of claim 13, wherein the case comprises a pair of apertures and wherein the mount comprises a pair of projections serving as a coupler, the pair of projections to be removably received within the pair of apertures and to serve as the coupler.

15. The system of claim 14, wherein the case comprises a second pair of apertures angularly offset from the pair of apertures by 90 degrees.

16. The system of claim 13, wherein the case is magnetically attractable to the base.

17. The system of claim 13, wherein the pair of prongs comprise hooks extending in directions opposite to one another to engage interior edges of the spaced automobile vent louver blades.

18. The system of claim 13, wherein the pair of prongs have opposing faces to contact corresponding faces of the spaced automobile louver blades and wherein the mount further comprises a resiliently compressible pad on each of the opposing faces.

19. The system of claim 18 further comprising an adhesive on each resiliently compressible pad to adhere the resiliently compressible pad to the corresponding face of the corresponding spaced automobile louver blade.

20. The system of claim 13, wherein the case comprises a pair of apertures and wherein the mount further comprising a second pair of prongs extending from the base and removably received within the pair of apertures, the second pair of prongs and the apertures configured such that the case is pullable off of the second pair of prongs in a direction perpendicular to a face of an electronic device received within the case;
wherein the base in the case are magnetically it attracted to one another at a location between the second pair of prongs.
